(19) United States
(12) Patent Application Publication
(10) Pub. No.: US 2007/0016611 A1
(43) Pub. Date: Jan. 18, 2007

(54) Preview method for seeking media content

(75) Inventor: Chien-Min Wang, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/180,282

(22) Filed: Jul. 13, 2005

(51) Int. Cl. G06F 17/00

(52) U.S. Cl. 707/104.1

(57) ABSTRACT

The present invention provides an efficient preview method for seeking certain media content of the media source, such as a DVD, a VCD or a media file. With the present invention, the user could no longer seek the desired playing time blindly. Before the playing of the media source is switched to present the selected point, the user is able to preview the media content without interrupting the playing of a main window by the way of PIP, separated preview window or a dialog bubble. The steps of the method comprise: receiving a first data stream from a media source; decoding and rendering the first data stream to present the content thereof; receiving a second data stream from the media source when a seeking instruction is input, wherein the second data stream is acquired according to the seeking instruction; and decoding and rendering the second data stream to present the content thereof together with the content of the first data stream concurrently. Preferably, the content of the second data stream is presented in a preview window or a dialog bubble.

### FIELD OF THE INVENTION

The present invention is related to a preview method, particularly to a preview method for seeking specific media content while the movie or video is played.

### BACKGROUND OF THE INVENTION

With the development of multimedia technology, the user may utilize a computer or a portable device to enjoy the movies or videos. These equipments could not only play general VCD or DVD, but may also store some media data in certain storage medium, such as the hard disc or flash memory. Since the equipments usually have plural input devices, such as the mouse and the keyboard, it would be more convenient to control the equipments, and more functions are provided, as comparing with the VCD/DVD player associated with TV.

While viewing the movies on the terminal such as computer or the portable device, the user may tend to seek a specific playing time of the media source. Conventionally, the media playing software provides a timeline or progress bar to indicate the current playing time or playing ratio. With that timeline, the user could jump to any desired playing time by manipulating the mouse to click certain point on the timeline, and the playing window would present the media content represented by that point.

However, it is not always so lucky that the clicked point is just right the playing time that the user desiring to appreciate. In fact, the obtainment of the desired media content usually requires several clicks on the timeline. This is because the user could merely select and click the point on the timeline blindly. Before the played media content jumps to the selected playing time, the user never knows what content would be presented. Such a seeking scheme is naturally inefficient.

Besides, in the situation that the user would like to jump back to the original playing time, another time-consuming seeking procedure should be taken. The exact original playing time is usually difficult to be obtained through the traditional way. Thus an effective scheme for seeking specific media content should be provided.

Some art disclosed the PIP (picture in picture) technology, for example, U.S. Pat. No. 5,251,034, entitled “Automatic PIP channel searching apparatus and method”, it disclosed an automatic PIP channel search apparatus and method for, when operating a scan key while the user is watching television (TV) or a video tape on a video cassette recorder (VCR) using a TV having a PIP function, searching channels by taking,the currently-viewed picture as a main screen and taking the searched broadcasting channels as subscreens, to thereby facilitate the channel selection. However, it is merely for watching television (TV) or a video tape. A further prior art mentioned to the “Operator notation tool tip”, please refer to U.S. Pat. No. 6,504,556. However, the method is disclosed for a printing system, it provides a user interface with an operator tool tip for navigating and controlling the printing system. Another reference disclosed information cursors that are provided for use in an operating system and/or application programs. Each information cursor includes a pointing portion to point to objects displayed on a video display and an information portion to display information about an object to which the pointing portion points. Please refer to U.S. Pat. No. 6,437,800, wherein the patent is assigned to Microsoft Corporation (Redmond, Wash.). Another reference U.S. Pat. No. 6,809,720 of the same assignee is incorporated herein for reference.

### SUMMARY OF THE INVENTION

In view of the aforementioned problems, the present invention therefore discloses the preview methods for seeking certain media content. With the preview methods of the present invention, the user could preview the media content represented by any point of the timeline without interfering the playing of the main video. After checking the tangible media content, the user then is able to determine whether jumps to that point. If the desired point does not exist or is not found, the operation of jump might be omitted. The main video could be played as usual.

The purpose of the present invention is providing a preview method for seeking media content. First, a first data stream is received from a media source. Then the first data stream would be decoded and rendered to present the content therein. While the content of the first data stream is playing, a second data stream would be received from the media source, if the user inputs a seeking instruction. That is, the user may manipulate a mouse or certain cursor controller to select a point on a timeline to make such seeking instruction, and the second data stream is acquired accordingly. Finally, the second data stream would be decoded and rendered to present the content thereof together with the content of the first data stream concurrently. Preferably, the content of the second data stream is presented in a preview window or a dialog bubble.

Another purpose of the present invention is providing a preview method for seeking desired media content. First, a first data stream is received from a media source. Then the first data stream would be decoded and rendered to present the content therein. While the content of the first data stream is playing, a second data stream would be received from the media source if the user inputs a seeking instruction. That is, the user may manipulate a mouse or certain cursor controller to select a point on a timeline to make such seeking instruction, and the second data stream is acquired accordingly. Finally, the second data stream would be decoded, and the content of the second data stream would be presented together with the content of the first data stream concurrently by the way of picture-in-picture.

Yet another purpose of the present invention is providing a computer-readable storage medium having executable instructions for previewing and seeking media content by performing the following steps, which comprise: receiving a first data stream from a media source; decoding and rendering the first data stream to present the content thereof; receiving a second data stream from the media source when a seeking instruction is input, wherein the second data stream is acquired according to the seeking instruction; and decoding and rendering the second data stream to present the content thereof together with the content of the first data stream concurrently. Preferably, the content of the second data stream is presented in a preview window or a dialog bubble.

Still another purpose of the present invention is providing a computer-readable storage medium having executable instructions for previewing and seeking media content by performing the following steps, which comprise: receiving a first data stream from a media source; decoding and rendering the first data stream to present the content thereof; receiving a second data stream from the media source when a seeking instruction is input by a user, wherein the second data stream is acquired according to the seeking instruction; decoding the second data stream; and presenting the content of the second data stream together with the content of the first data stream concurrently by the way of picture-in-picture.

### BRIEF DESCRIPTION OF THE DRAWINGS

FIG. 1 is a flow chart of a method according to one embodiment of the present invention.

FIG. 2 is a block diagram illustrating a processing procedure of the media content.

FIG. 3 illustrates a main window as well as a preview window according to one embodiment of the present invention.

FIG. 4 illustrates a main window as well as a dialog bobble according to another embodiment of the present invention.

FIG. 5 is a flow chart of a method according to yet another embodiment of the present invention.

FIG. 6 is a block diagram illustrating a processing procedure of the media content.

FIG. 7 illustrates a main window which presents the media content by means of picture-in-picture.

FIG. 8 is a block diagram illustrating a processing procedure of the media content.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

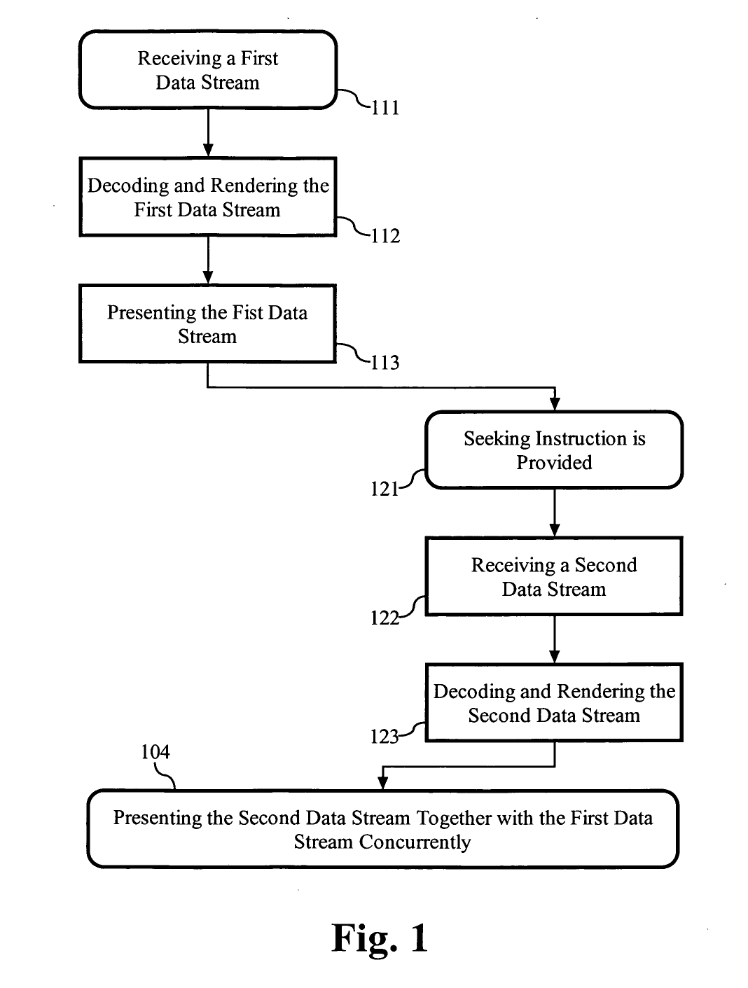

Referring to FIG. 1, a procedure of a preview method is illustrated in the flow chart. In a preferred embodiment of the present invention, when the user would like to appreciate the movie in a DVD, a VCD or a media file on the computer, the media player application would receive a first data stream from the media source, such as the DVD, as shown in step 111. After that, in step 112, the received first data stream would be decoded and rendered to present the media content therein. It should be appreciated that the techniques of the decoding and rendering are well known to those who have ordinary skill in the art, so the description thereof is omitted to avoid obscuring the present invention.

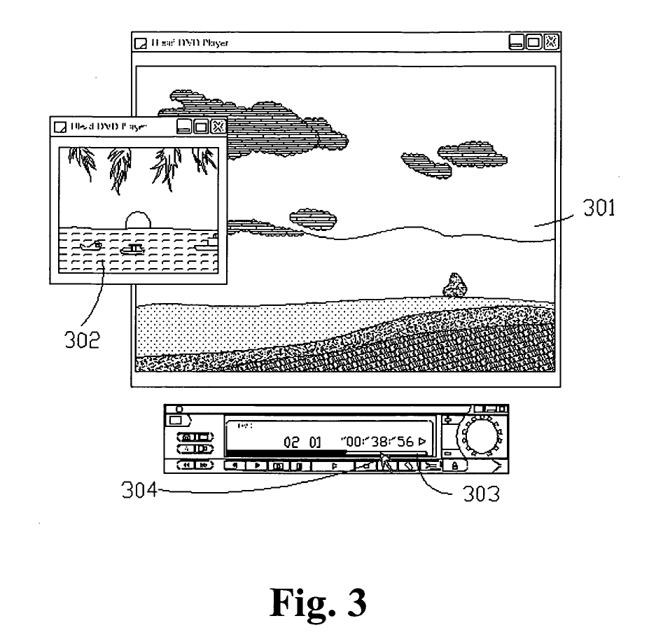

Next, in step 113, the content of the first data stream would be presented in a main window 301, as shown in FIG. 3. Referring to FIG. 3, the media player usually provides a control panel which includes a timeline 303. The timeline 303 would illustrate the ratio of the total playing length and the played length. Generally, the played portion may be highlighted. If the user would like to seek specific media content, a mouse is often applied to select a point on the timeline 303. In FIG. 3, the cursor is put ahead the current playing point on the timeline. Conventionally, the media content on the selected point is unknown until the playing of the DVD jumps to that point. However, the present invention provides a novel way to seek specific point by previewing the media content without interfering the playing of the DVD.

Referring back to FIG. 1, if a seeking instruction is provided by the user in step 121, that is, if the user manipulates the mouse to select a point on the timeline 303, a second data stream would be received from the DVD, as shown in step 122. The second data stream is acquired according to the seeking instruction, and such seeking instruction includes a seeking time represented by the selected point on said timeline. In other words, the second data stream should be associated with the point designated by the user and therefore contain the media content which would be previewed. In step 123, the second data stream is decoded and rendered. It should be noted that the presenting of the first data stream would not be interrupted in the process of the receiving, decoding and rendering of the second data stream.

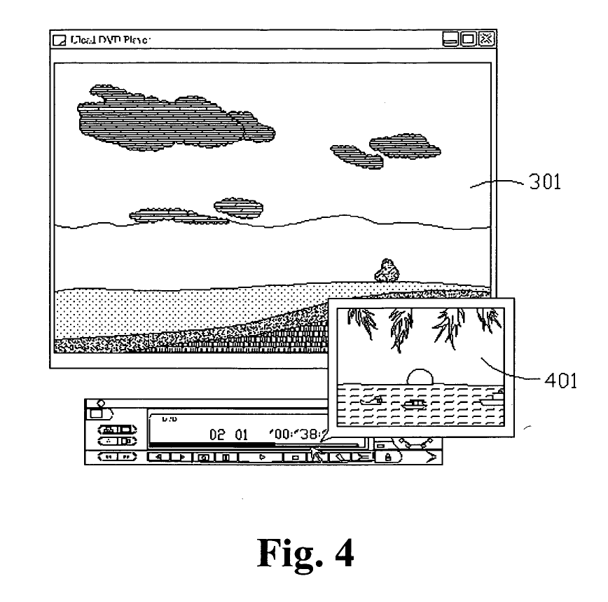

In step 104, the content of the second and first data streams would be presented jointly and concurrently, as shown in FIG. 3 and FIG. 4. In one embodiment of the present invention, the media content of the second data stream is presented in the preview window 302 in FIG. 3. Moreover, in another embodiment of the present invention, the media content of the second data stream is presented in the dialog bobble 401 in FIG. 4. In each embodiment, the playing of the first data stream on the main window 301 would not be interrupted.

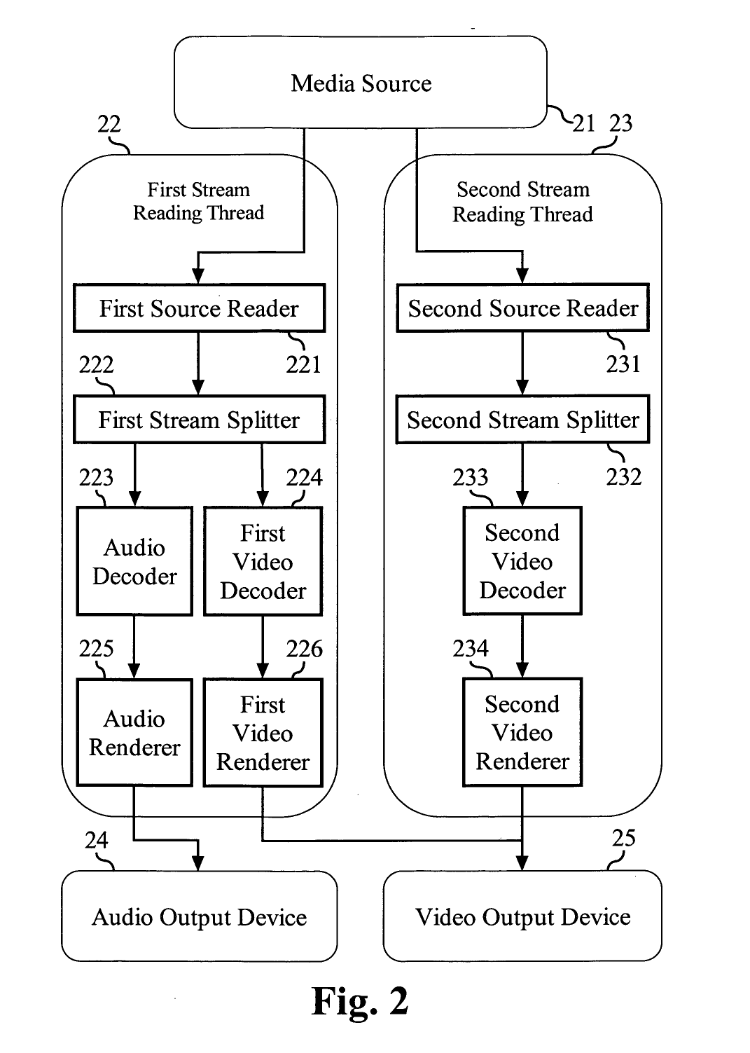

Referring to FIG. 2, a block diagram would illustrate the data flow and processing procedure according to the preferred embodiment of the present invention. The media content of the first and second data streams are provided from the media source 21, for example, a DVD or a movie file. The processing of the data streams are divided into two reading threads 22 and 23. In thread 22, the first data stream is received by the first source reader 221, and then the received data would be passed to the first stream splitter 222. The first stream splitter 222 would split the data into two data portions, which are audio data portion and video data portion. The audio data portion is then decoded by the audio decoder 223 and rendered by the audio renderer 225. After that, the rendered audio data portion would be output by the audio output device, such as a sound effect card and a speaker. Similarly, the video data portion would be decoded by the first video decoder 224 and then rendered by the first video renderer 226. The rendered video data portion would finally be output by the video output device 25, such as a video card connecting to a LCD monitor. It should be noted that the processing of the first data stream may still be implemented by other suitable way, and the above description is merely cited for exemplification.

If the seek instruction is provided, the second data stream would be retrieved from the media source 21 to the second source reader 231 according to the seek instruction. Similarly, the second data stream would be split by the second stream splitter 232. In the preferred embodiment of the present invention, only the video data of the second data stream is required. That is, the preview function merely enables the preview of visual content, instead of audio content. Nevertheless, in other embodiment, the preview content may include the audio content. After the video data portion is abstracted by the second stream splitter 232, the video data would be decoded by the second video decoder 233 and then rendered by the second video renderer 234. Finally, the rendered video data would be provided to the video output device 25 which is presenting the video content of the first data stream. Therefore, the media content of the second data stream would be presented together with the media content of the first data stream concurrently.

Besides the separated preview window or the dialog bobble, the preview media content may be presented in other ways. It should be noted that the above embodiments are merely cited for illustration, instead of limitation.

In one embodiment of the present invention, the preview media content may also be presented in the main window. This could be accomplished by the technique of picture-in-picture (PIP). In other words, one portion of the main window could be applied to display the preview media content while the main window is presenting the media content of the first data stream.

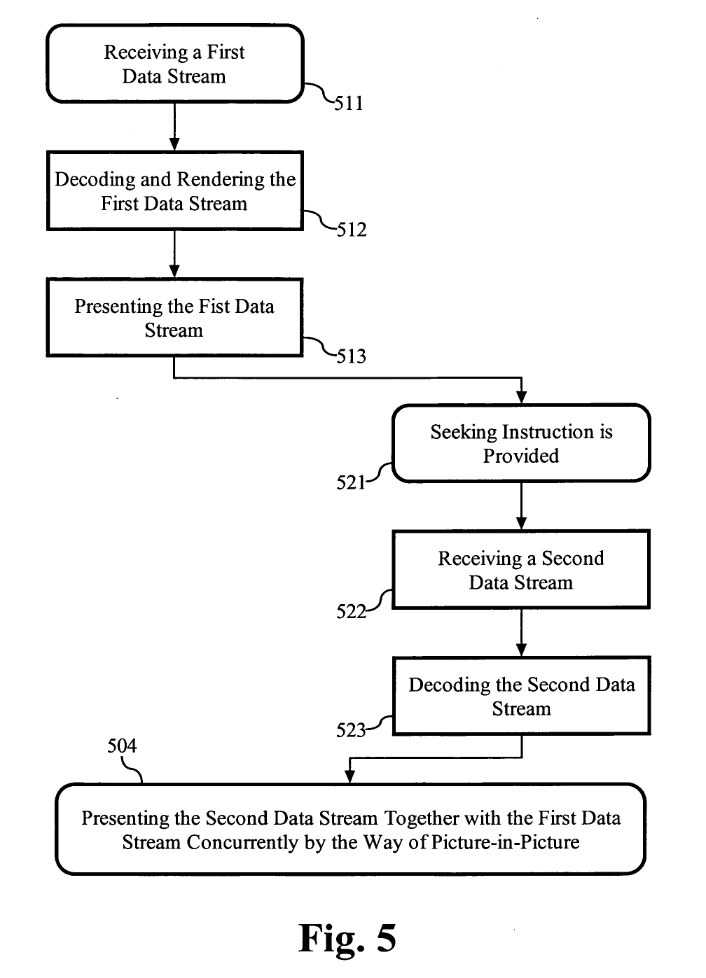

Please refer to FIG. 5, and the flow chart of one embodiment of the present invention is illustrated. The procedure is similar with that of the FIG. 1 except that the decoded second data stream is not rendered immediately, as shown in step 521-523. To phrase another words, the step 523 omitted the process of rendering as comparing with step 123. Since the media content of the second data stream would be presented in the same window of the first data stream, both of which would be rendered jointly after being overlaid and mixed. In step 504, the media content of the first and the second data stream would be presented concurrently in the same window by the way of PIP.

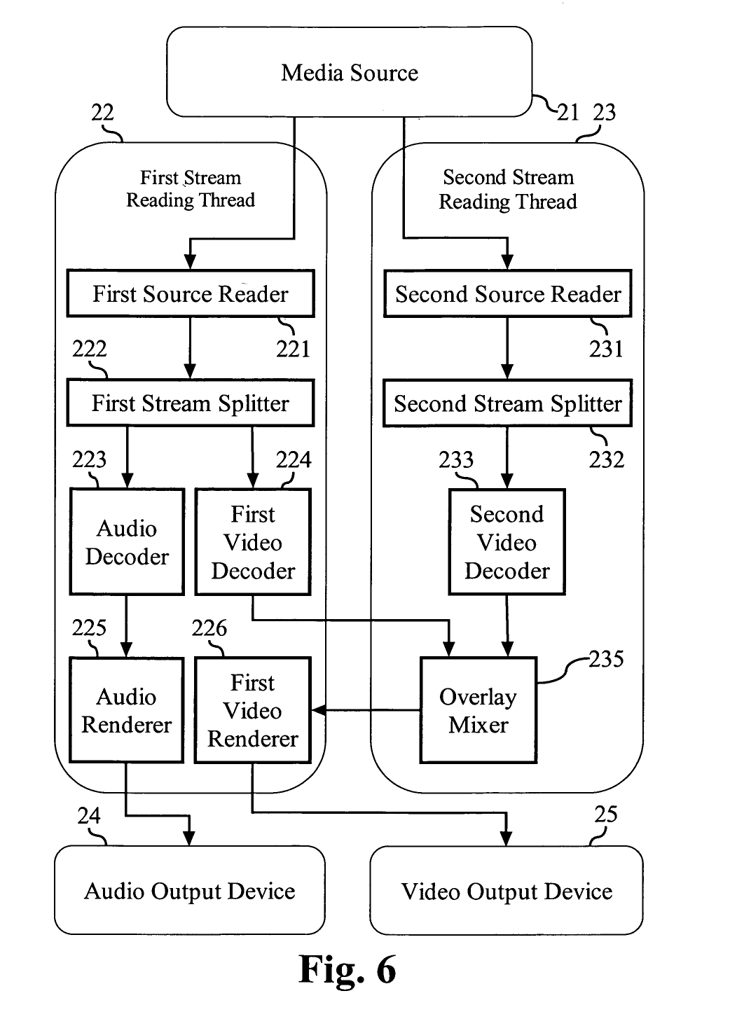

Referring to FIG. 6, the block diagram would illustrate the data flow and processing procedure according to the embodiment of FIG. 5. This block diagram is similar with the FIG. 2 except that the second renderer 234 is replaced by the overlay mixer 235 and the decoded first and second data streams would be rendered jointly by the first video renderer 226. The overlay mixer 235 could mix and overlay the visual content of the decoded first and second data streams. The detailed techniques of the PIP are known to those who have ordinary skill in the art and therefore omitted herein to avoid obscuring the present invention.

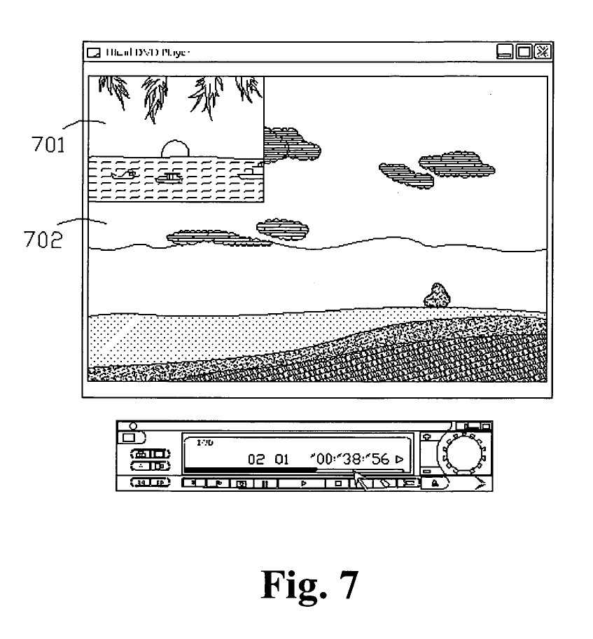

After the mixed video data portions of the first and second data streams are rendered by the first video renderer 226, the rendered data would be transferred to the video output device 25 to present the video content in the way of PIP. In FIG. 7, a portion 701 of the window 702 is applied to present the preview video content. This displaying scheme is so-called picture-in-picture.

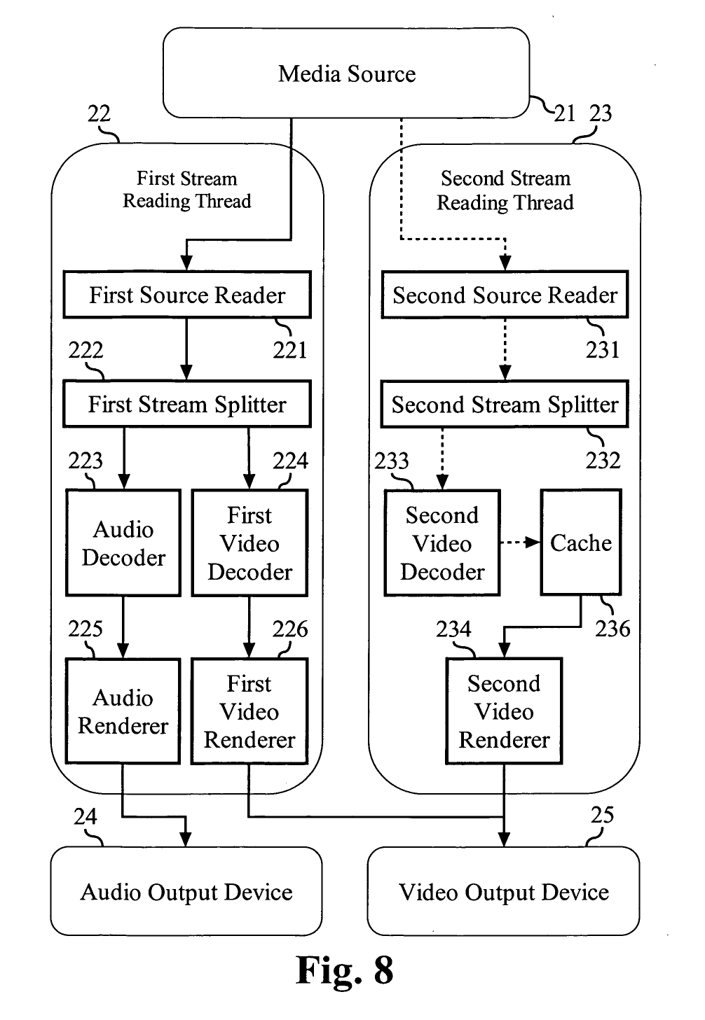

Referring to FIG. 8, in one embodiment of the present invention, a cache 236 may be provided to preserve certain media data. If the designated preview media content has been included in the cache 236, the renderer 234 could directly access the cache 236 to speed up the processing. Generally, the cache 236 would keep certain portion of the media data from the media source. The portion may indicate a time range, and if the time associated with the designated point falls within the range, the desired media content could be obtained from the cache 236. The accessing of the media source as well as the decoding of the second data stream could thus be omitted to reduce the processing time. In one embodiment of the present invention, the preserved portion may include the media data belonging to a neighborhood around a presenting point on the timeline, wherein the presenting point stands for a time that the content of the first data stream is presenting at. It should be noted that although the scheme of cache 236 is applied in the embodiment illustrate in FIG. 2, any other embodiments, such as that of FIG. 6, could also be provided with the cache 236.

Since the steps and procedures of the FIGS. 5-6 and 8 are similar to those of FIGS. 1 and 2, the identical descriptions are omitted to avoid redundancy. As it is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A preview method for seeking media content, which comprises:
receiving a first data stream from a media source;
decoding and rendering said first data stream to present said first data stream;
receiving a second data stream from said media source when a seeking instruction is input, wherein said second data stream is acquired according to said seeking instruction; and
decoding and rendering said second data stream to present said second data stream together with said first data stream concurrently.

2. The preview method as set forth in claim 1, wherein said seeking instruction is input by a mouse or a cursor controller to select a point on a timeline.

3. The preview method as set forth in claim 2, wherein said seeking instruction includes a seeking time represented by said point on said timeline.

4. The preview method as set forth in claim 3, which further comprises:
providing a cache for preserving a portion of media data from said media source; and
accessing said cache for acquiring said second stream if said seeking time falling in a time range indicative of said portion.

5. The preview method as set forth in claim 4, wherein said portion of media data includes media data belonging to a neighborhood around a presenting point on said timeline, and said presenting point stands for a time that said first data stream is presenting at.

6. The preview method as set forth in claim 1, wherein said second data stream is presented in a preview window or a dialog bubble.

7. The preview method as set forth in claim 1, wherein said second data stream is decoded and rendered to present visual content thereof.

8. The preview method as set forth in claim 1, wherein said media source includes a media file, a VCD or a DVD.

9. A preview method for seeking media content, which comprises:
receiving a first data stream from a media source;
decoding and rendering said first data stream to present said first data stream;
receiving a second data stream from said media source when a seeking instruction is input, wherein said second data stream is acquired according said seeking instruction;
decoding said second data stream; and
presenting said second data stream together with said first data stream concurrently by the way of picture-in-picture.

10. The preview method as set forth in claim 9, wherein said seeking instruction is input by a mouse or a cursor controller means to select a point on a timeline.

11. The preview method as set forth in claim 10, wherein said seeking instruction includes a seeking time represented by said point on said timeline.

12. The preview method as set forth in claim 11, which further comprises:
providing a cache for preserving a portion of media data from said media source; and
accessing said cache for acquiring said second stream if said seeking time falling in a time range indicative of said portion.

13. A computer-readable storage medium having executable instructions for previewing and seeking media content by performing the following steps, which comprise:
receiving a first data stream from a media source;
decoding and rendering said first data stream to present said first data stream;
receiving a second data stream from said media source when a seeking instruction is input, wherein said second data stream is acquired according to said seeking instruction; and
decoding and rendering said second data stream to present said second data stream together with said first data stream concurrently.

14. The computer-readable storage medium as set forth in claim 13, wherein said seeking instruction is input by a mouse or a cursor controller means to select a point on a timeline, and said seeking instruction includes a seeking time represented by said point on said timeline.

15. The computer-readable storage medium as set forth in claim 14, wherein said steps further comprise:
providing a cache for preserving a portion of media data from said media source; and
accessing said cache for acquiring said second stream if said seeking time falling in a time range indicative of said portion.

16. The computer-readable storage medium as set forth in claim 13, wherein said second data stream is presented in a preview window or a dialog bubble.

17. A computer-readable storage medium having executable instructions for previewing and seeking media content by performing the following steps, which comprise:
receiving a first data stream from a media source;
decoding and rendering said first data stream to present said first data stream;
receiving a second data stream from said media source when a seeking instruction is input, wherein said second data stream is acquired according to said seeking instruction;
decoding said second data stream; and
presenting said second data stream together with said first data stream concurrently by the way of picture-in-picture.

18. The computer-readable storage medium as set forth in claim 17, wherein said seeking instruction is input by a mouse or a cursor controller means to select a point on a timeline.

19. The computer-readable storage medium as set forth in claim 18, wherein said seeking instruction includes a seeking time represented by said point on said timeline.

20. The computer-readable storage medium as set forth in claim 19, which further comprises:
providing a cache for preserving a portion of media data from said media source; and
accessing said cache for acquiring said second stream if said seeking time falling in a time range indicative of said portion.
